(19) United States
(12) Patent Application Publication
(10) Pub. No.: US 2004/0146168 A1
(43) Pub. Date: Jul. 29, 2004

(54) Adaptive sound scrambling system and method

(76) Inventors: Rafik Goubran, Nepean (CA); Radamis Botros, Ottawa (CA)

Correspondence Address: Welsh & Katz, Ltd., 22nd Floor, 120 South Riverside Plaza, Chicago, IL, 60606, US

(21) Appl. No.: 10/756,593

(22) Filed: Jan. 13, 2004

Related U.S. Application Data
(63) Continuation-in-part of application No. 09/998,191, filed on Dec. 3, 2001, now abandoned.

(51) Int. Cl. H04R 3/02

(52) U.S. Cl. 381/73.1

(57) ABSTRACT

An adaptive sound masking and/or scrambling system and method portions undesired sound into time-blocks and estimates frequency spectrum and power level, and continuously generates white noise with a matching spectrum and power level to mask the undesired sound.

### BACKGROUND OF THE INVENTION

1. Field of the Invention

The present invention is directed to systems for masking and/or scrambling undesired sounds in general, and in particular to an adaptive noise generating system to mask interfering sounds emanating or leaking from other sources to mitigate their effects on the listeners. The invention is also directed to systems for scrambling the speech leaking from a given location so that unauthorized listeners do not understand its contents. In both cases the system tracks the amplitude range and the frequency range of the undesired sound and adaptively generates another sound to achieve its objectives.

2. Prior Art of the Invention

Generation of masking background noise in order to reduce the intelligibility of sounds leaked from adjacent areas or sources is generally known in the art. The commonly known masking systems generate constant background noise, the spectrum of which is shaped in such a way as to mask the speech at least to some extent.

There are some problems associated with such approach, such as:

the amplitude range (or level) of the noise is constant and does not adapt to the room conditions;

the frequency range (or spectrum) of the noise is constant and does not adapt to the room conditions;

the masking noise does not stop when the room is silent which makes it annoying to the listeners;

the masking noise does not completely scramble the leaked speech unless its level is extremely high which could make it very annoying to the listeners; and

existing noise masking systems are central. For example, in the case of an open plan office, exiting noise masking systems are installed in the ceiling of the office and not on each partition. Their parameters are adjusted based on an estimate of the room conditions and not the needs of each partition.

Other prior art deals with tracking the amplitude of the ambient background noise in order to adjust the volume of a device. In U.S. Pat. No. 4,553,257 to Mori et al. an automatic sound volume control to adjust the volume of a device based on the ambient noise environment. Their noise level detector (block 2) is used to adjust the gain of an external signal (S0). The disclosure is directed to amplifying and reproducing this external sound signal in the presence of undesired ambient noise, and is not concerned with masking the external sound signal, nor does it address the frequency spectrum of the ambient noise.

Other prior art deals with tracking the frequency of a signal. Published application US 2001/0028634 A1 Huang et al. is concerned with voice transmission in packet networks. A method to replace voice packets that are lost in the network. Their method is based on replacing the lost packets by noise that has spectral characteristics similar to the voice packets surrounding the lost packet. This way the speech quality remains good despite loss of a packet. The method is a packet concealment technique that maintains a good speech quality and intelligibility.

In U.S. Pat. No. 4,438,526 to Thomalla an automatic volume and frequency controlled sound masking system is disclosed, which comprises a microphone that senses the ambient noise and controls a random noise generator. A number of predefined frequency bands are defined and used in the sensing and generation processes. The output signal does not change unless the change in the input signal has a predetermined duration of at least about 30 seconds.

### SUMMARY OF THE INVENTION

The present invention provides a system and method for continuously adapting to the undesired signal characteristics not limited by any predetermined frequency bands or duration of the undesired signal. The system is also intended to scramble the speech and significantly reduce its intelligibility. Furthermore, the novel system is a distributed one that can accommodate multiple users and adapts to the needs of each partition in a room independently.

The present invention endeavors to mitigate some of the prior art problems by providing a system and method in which:

The masking noise adapts, dynamically, to the characteristics of the leaked interfering sound by having an appropriate amplitude range and an appropriate frequency range;

The amplitude range of the masking sound is minimized while achieving the desired reduction in intelligibility and scrambling.

The frequency range of the masking noise is minimized while achieving the desired reduction in intelligibility and scrambling.

The amplitude range and/or frequency range of the masking noise is varied depending upon the specific application and user needs. For example, the amplitude range is relatively small for masking applications and large for scrambling applications.

The system is a distributed system and not a centralized one. It adapts to the needs of each partition in the room independently.

More particularly, the method of the present invention comprises the following steps:

(i) acquire the undesired sound from a given location in the room using a microphone, amplifier, filter, sample/hold, and analog/digital converter; the sampling rate in our experiments was set at 16 kHz. However, the sampling rate could vary depending upon the specific application, desired performance, and hardware configuration.

(ii) partition the acquired signal to form signal blocks (their size depends upon the specific application, in our experiment this value varied from 10 to 1024 msec); The block size determines the frequency tracking performance.

(iii) estimate the undesired sound power of the signal in each block. (for example by adding the squares of the samples and dividing by the total number of samples in the block);

(iv) filter the values of the estimated undesired sound power calculated in step (iii) using a low-pass-filter to obtain a smooth running average of the undesired signal power. The cut-off frequency of the filter determines the desired amplitude tracking performance; A high cut-off frequency results into aggressive scrambling that may be annoying in some applications. Whereas a low cut-off frequency results in a smooth scrambling that may be less effective but also less annoying to the listeners. In our experiment we used a cut-off frequency of 0.1 Hz.

(v) estimate the frequency spectrum of each time block resulting from step (ii);

this could be done for example by calculating the Fast Fourier Transform (FFT) of each block. The FFT coefficients are indicative of the frequency spectrum of the time block;

(vi) calculate the maximum and minimum frequencies of the signal in each block based on the frequency spectrum estimated in step (v);

(vii) generate a white noise signal and filtering it with a band-pass filter. The pass-band of the filter is in the range fₘₐₓ to fₘᵢₙ which are related to the maximum and minimum frequencies calculated in step (vi). In our experiments fₘₐₓ and fₘᵢₙ were set at half of the maximum and minimum frequencies calculated in step (vi) respectively. This relationship depends upon the desired compromise between the level of scrambling and the degree of annoyance to the listener. A wider band leads to better scrambling but also more annoyance and vice versa. The pass band of the filter is designed to whiten the undesired speech. It amplifies the noise in the frequency bands where the undesired sound is low and attenuates it in the frequency bands where the undesired sound is high. This process is implemented by calculating the FFT coefficients of the desired filter from the FFT coefficient representing the undesired signal from step (v);

(viii) multiply the filtered noise generated by step (vii) by the smooth running average of the power of the undesired sound generated by step (iv);

(ix) feed the signal generated from step (viii) to an amplifier and loudspeaker to generate the masking and/or scrambling noise.

The system to carry out the above method is preferably a stand-alone circuit board based on an energy efficient DSP processor and memory, and an analog interface chip (AIC). A suitable DSP is sold by Texas instruments as Part No. TMS320-C542 or Part No. TMS320-C671 1, and a suitable AIC by the same company is, for example, Part No. TLC32040. Of course, other similarly suitable devices are available in the marketplace.

### BRIEF DESCRIPTION OF THE DRAWINGS

The preferred exemplary embodiments of the present invention will now be described in detail in conjunction with the annexed drawings, in which:

FIG. 1 is a block diagram of the adaptive system for sound making according to the present invention;

FIG. 2 is a block diagram of the noise-shaping filter shown in FIG. 1; and

FIG. 3 depicts the preferred system requirements for the adaptive system shown in FIG. 1.

### DETAILED DESCRIPTION OF THE DRAWINGS

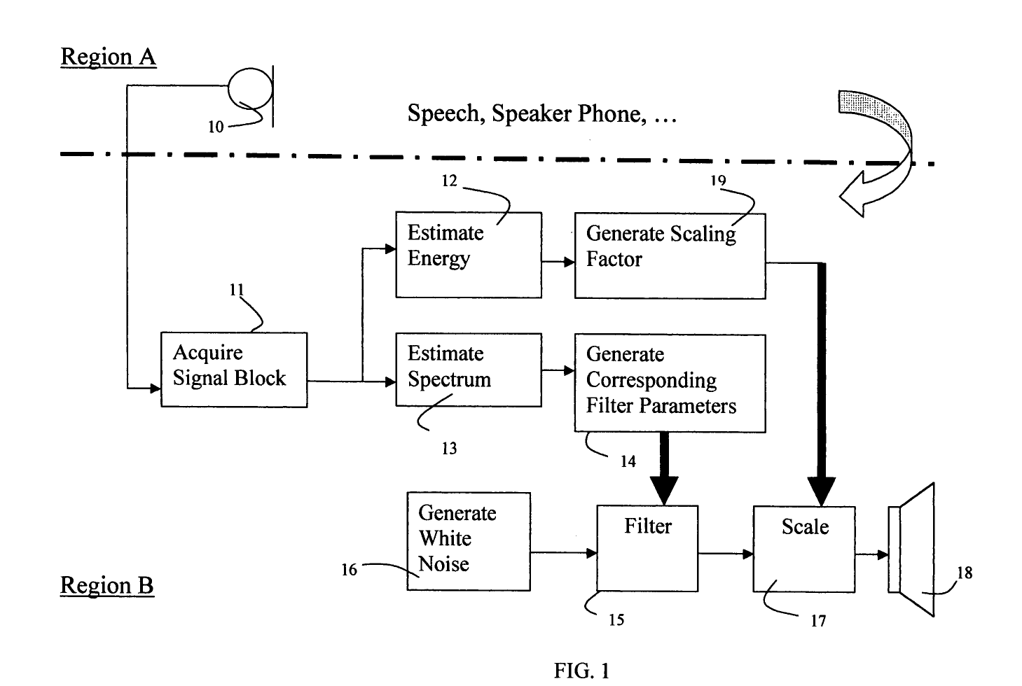

Referring to FIG. 1 of the drawings, the system of the present invention comprises a microphone 10 located at the border of, or in, a region A from which an interfering sound is leaking into a region B (the masking region). The output signal from the microphone is applied to and partitioned into output signal blocks of, say, between 10 and 1024 msec in acquisition circuit 11, the output of which is applied to energy and spectrum estimators 12 and 13, respectively. The estimated spectrum output is applied to a spectrum shaping generator 14 which generates shaping filter 15 parameters. The filter 15 filters the output of a white noise generator 16 and applies the spectrally conditioned white noise to a scaling amplifier 17, which drive a masking loudspeaker 18 located in the region of interval B. The scaling amplifiers 17 gain is controlled by a scaling factor generator 19, which is driven by the energy estimator 12, said that the higher the estimated interfering sound energy from the region A, the larger is the gain of the scaling amplifier 17.

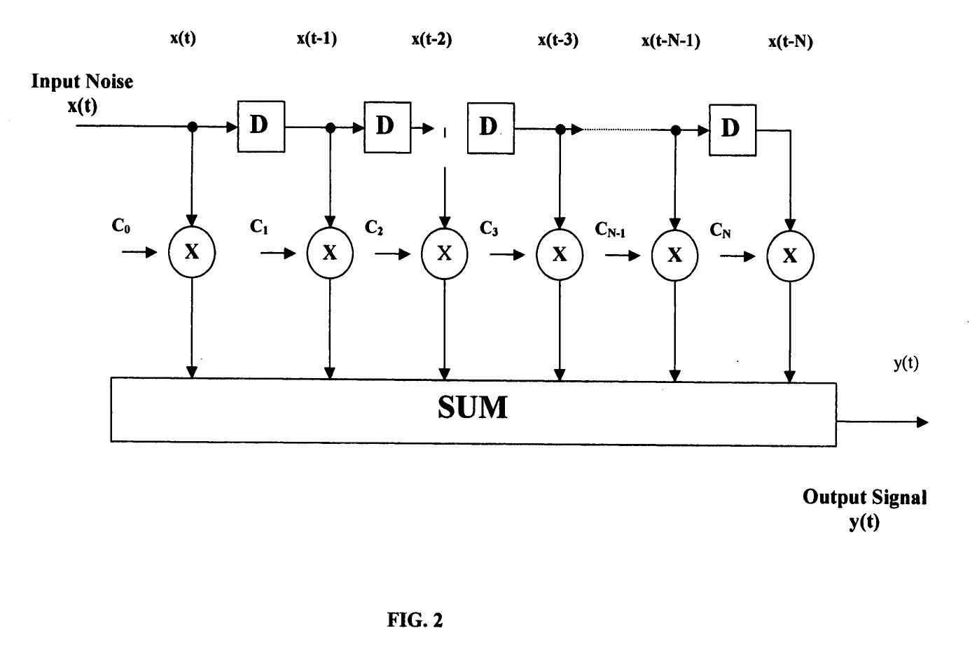

The spectrum shaping filter 15 is shown in FIG. 2. Several approaches could be used to design the filter. In this implementation a Finite Impulse Response filter was used. The filter 15 receives the input white noise x(t), processes it in (N+1) stages separated by N equal delays D, the outputs of which are multiplied by factors Cₒ to C_{N} then summed to yield the filter output signal y(t) that represents the spectrally shaped output noise. D represents a one sample delay; with a sampling rate of 16 kHz the delay D is 1/16 kHz=0.0625 msec. The signal y(t) is then applied to the scaling amplifier 17. Thus, the output y(t) is a modified version of x(t) as follows:

$$y ( t ) = {\sum }_{k = o}^{k = N} {C}_{k} x ( t - k )$$

where

t is the time-slot member within a block;

x(t) is the input white noise;

Cₒ to C_{N} are the filter coefficients;

N is the number of delay elements in the filter; and

y(t) is the output signal.

The number of samples (tₘₐₓ) within a block, assuming a block length of 256 msec and a sampling rate of 16 kHz (0.0625 msec) simply is

$$\frac{256}{0.0625} = 4 , 096 samples$$

The filter coefficients Cₒ to Cₖ are derived from the FFT coefficients of the undesired sound. They are generated by block 14 as follows:

Block 13 estimates the spectrum of the undesired sound. A possible implementation is the use of windowing and FFT. Assuming a block size of 4,096 samples, a 256-points FFT, a Hamming window, and an overlap factor of 2. A Hamming window of size 256 generates 256 values from samples x(0) to x(255). A 256-points FFT operation is performed. Its coefficients represent an estimate of the frequency spectrum of the first 256 input data points. The Hamming widow then generates another 256 values from input samples x(128) to x(383) and the same operation is repeated for the whole block. The average of the FFT coefficients represents an estimate of the spectrum of this given block of the undesired sound input.

Based on this estimated spectrum, the desired frequency response of filter 15 is determined. A possible implementation is described in steps (v), (vi), and (vii) of the proposed method summary of this invention.

The filter coefficients CO to CN are calculated using the conventional frequency domain based filter design technique for FIR filters as described in any standard undergraduate signal processing textbook, (e.g. pages 630-632 of John G. Proakis and Dimitris G. Manolakis, “Digital Signal Processing: Principles, Algorithms, and Applications”, Third edition, Prentice Hall, 1996, ISBN 0-13-373762-4, which is incorporated herein by reference).

The scaling factor controlling the gain of the scaling amplifier 17 would conveniently by adjustable depending on the proximity of individual(s) in the regionally to the loudspeaker(s) 18. However, the spectrum estimator 13 would simply cause the generation of filter parameter to match the interfering spectrum.

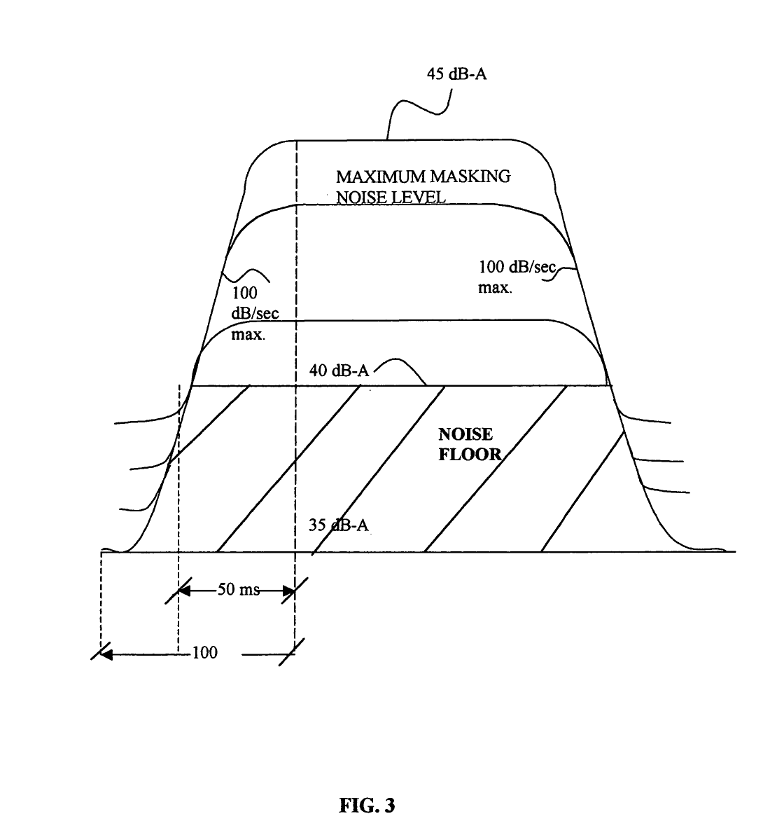

FIG. 3 shows the preferred system performance requirements, with a noise-floor between 35 dB-A (A-weighted) and 40 dB-A. Most systems in an office environment would not require a masking noise level higher than 45 dB-A, but this is a designer discretion.

What is claimed is:

1. A method for adaptive sound masking or scrambling comprising the steps of
(i) acquiring a signal representing undesired sound;
(ii) partitioning the acquired signal into blocks;
(iii) estimating the sound power in each time block resulting from step (ii);
(iv) filtering the values of the estimated sound power estimated in step (iii) using a low-pass-filter, whereby cut-off frequency of the filter determines the desired amplitude tracking performance;
(v) estimating the frequency spectrum of each time block resulting from step (ii);
(vi) determining maximum and minimum frequencies of the signal in each of said blocks based on the frequency spectrum estimated in step (v);
(vii) generating a white noise signal and filtering it with a band-pass filter, having an upper range of pass-band equal to the maximum frequency determined in step (vi) and having a lower range equal to the minimum frequency determined in step (vi);
(viii) filtering the signal resulting from (vii) to shape its spectrum in a predetermined manner; and
(ix) adaptively varying the amplitude range and frequency range of the generated noise.

2. A system for adaptive sound masking comprising:
(i) means for acquiring a signal representing undesired sound;
(ii) means for partitioning the acquired signal into blocks;
(iii) means for estimating sound power level in the time blocks;
(iv) means for estimating frequency spectrum in the time blocks;
(v) means for generating white noise with a shaped spectrum and at a power level matching levels estimated in steps (iii) and (iv); and
(vi) means for adaptively adjusting the amplitude range and frequency range of this noise.

3. A system for adaptive sound scrambling comprising:
(i) means for acquiring a signal representing undesired sound;
(ii) means for partitioning the acquired signal into blocks;
(iii) means for estimating sound power level in the time blocks;
(iv) means for estimating frequency spectrum in the time blocks;
(v) means for generating white noise with a shaped spectrum and at a power level matching levels estimated in steps (iii) and (iv); and
(vi) means for adaptively adjusting the amplitude range and frequency range of this noise.
